(19) United States
(12) Patent Application Publication
(10) Pub. No.: US 2005/0201909 A1
(43) Pub. Date: Sep. 15, 2005

(54) Catalyst

(75) Inventors: Richard Carroni, Niederrohrdorf (CH); Timothy Griffin, Ennetbaden (CH)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: ALSTOM Technology LTD., Baden (CH)

(21) Appl. No.: 11/066,736

(22) Filed: Feb. 28, 2005

Related U.S. Application Data
(63) Continuation of application No. PCT/CH03/00406, filed on Jun. 23, 2003.

(51) Int. Cl. B01J 8/00

(52) U.S. Cl. 422/222; 422/211; 422/190

(57) ABSTRACT

The present invention relates to a catalyst (1) for combustion of at least a portion of a gaseous fuel-oxidant mixture flowing through the catalyst (1), in particular for a burner of a power plant. An inlet sector (5) comprises inlet channels (9). A succeeding sector (6) comprises succeeding channels (10). The succeeding channels (10) have smaller internal cross-sectional areas than the inlet channels (9).

To improve the production of the catalyst (1), the invention proposes channels (3) which extend through the inlet sector (5) and through the succeeding sector (6) and have the internal cross-sectional area of the inlet channels (9). The inlet channels (9) are formed by portions of the channels (3) lying in the inlet sector (5). The succeeding channels (10) are provided by arranging separation walls (11) within portions of the channels (3) lying in the succeeding sector (6), the separation walls (11) dividing each of the respective channel portions in the succeeding sector (6) into two succeeding channels (10).

### FIELD OF THE INVENTION

The present invention relates to a catalyst for combustion of a portion of a gaseous fuel-oxidant mixture flowing through the catalyst, in particular for a burner of a power plant, having the features of the preamble of claim 1.

### DISCUSSION OF BACKGROUND

U.S. Pat. No. 4,154,568 has disclosed a catalyst of the type described in the introduction, the body of which is composed of a plurality of part-bodies arranged one behind the other in a main throughflow direction of the catalyst. The individual part-bodies are in each case designed as monoliths which in each case form a sector of the catalyst. The monolith through which medium flows first therefore includes an inlet of the catalyst and therefore forms an inlet sector, while the following monoliths form succeeding sectors. The individual monoliths include channels, also referred to as cells. In the known catalyst, the cell density increases in the main throughflow direction, while the cell size decreases. In other words, the inlet channels which are formed in the inlet sector and are present in a smaller number each have larger internal cross-sectional areas than the succeeding channels, which are present in a greater number, of the succeeding sectors which follow it. The intention of this configuration of the known catalyst is to effect improved ignition at the inlet and complete combustion of the fuel-oxidant mixture within the catalyst.

U.S. Pat. No. 5,346,389 has disclosed a catalyst which has a plurality of catalytically active channels and a plurality of catalytically inactive channels. This catalyst is produced with the aid of plates which are corrugated or folded in zigzag form and are formed into a layered arrangement by being placed on top of one another, wound helically or by being folded to and fro. The corrugations or folds then form the channels of the catalyst. One side of the respective plate is designed to be catalytically active with the aid of a catalyst coating. Therefore, the layered arrangement produces the catalytically active channels and the catalytically inactive channels. The conversion or combustion of the fuel-oxidant mixture takes place in the catalytically active channels. There is substantially no conversion or combustion of the mixture in the uncoated or catalytically inactive channels, and consequently this part of the flow of mixture can be used to dissipate heat, i.e. to cool the catalyst.

The known catalysts generally require a relatively large installation space, which may not be available in certain installation situations, in particular in the case of a burner of a power plant. In particular if a relatively high degree of conversion of the fuel carried in the mixture is to be achieved during flow through the catalyst, this generally leads to a relatively long construction in the main throughflow direction. However, a relatively short construction in combination with a relatively high degree of conversion is desirable in particular for gas turbine applications.

### SUMMARY OF THE INVENTION

The invention seeks to remedy this problem. The invention, as characterized in the claims, deals with the problem of providing an improved embodiment, which in particular is of comparatively compact structure and can be used to achieve a relatively high degree of conversion in the fuel-oxidant mixture, for a catalyst of the type described in the introduction.

This problem is solved by the subject matter of the independent claim. Advantageous embodiments form the subject matter of the dependent claims.

The invention is based on the general concept of forming the succeeding channels which are equipped with the smaller internal cross-sectional areas by introducing separation walls into channels in the succeeding sector which extend into the inlet sector, where they form the inlet channels. In this way, the channels provided with the separation walls in the succeeding sector are divided into two or more succeeding channels, which each have a smaller internal cross-sectional area than the inlet channels. The outlay involved in producing a catalyst of this type is relatively low, since given a suitable design the separation walls can be integrated in the succeeding sector relatively easily. Moreover, the proposed design makes it possible to achieve a relatively high cell density, which increases the conversion rate and reduces the dimensions of the catalyst.

According to a preferred embodiment, the length of the inlet sector in the main through flow direction is selected in such a way that, in a rated operating state of the catalyst, in particular of the burner equipped with the catalyst, there is a diffusion-controlled reaction within the inlet sector at the catalytic surfaces of the catalytically active inlet channels. This embodiment takes account of the fact that when the reaction process which is controlled by the diffusion and is therefore limited is reached, only a relatively slight rise in the conversion rate can be achieved over a greater length of the inlet sector, whereas, in the downstream succeeding sector, the conversion rate rises significantly if the length increases, in particular on account of the larger catalytically active surface area. In particular, a state with a thermally limited reaction, in which limiting the reaction through diffusion phenomena is of no importance or only limited importance, can be achieved in the succeeding sector, so that the conversion rate is substantially determined by the prevailing temperature.

The catalyst can also be configured in such a way that the length of the inlet sector in the main throughflow direction is greater than the development length of a hydrodynamic boundary layer which is formed in the channels in a rated operating state of the catalyst, in particular of the burner equipped with the catalyst. This design takes account of the fact that a diffusion-limited or diffusion-controlled reaction (tends to) form(s) in a developed boundary layer flow. Furthermore, this takes account of the knowledge that with larger internal cross-sectional areas, the development length of the boundary layer is shorter, on account of the faster conversion from laminar flow to turbulent flow, and that only a reduced dissipation of heat is possible in a developed boundary layer compared to a boundary layer which is still developing. Accordingly, a heterogeneous catalyst reaction can be ignited in the inlet channels having the larger internal cross-sectional areas even over a short length. Consequently, the overall catalyst is of relatively short construction.

In a refinement, the dimensioning of the catalyst is deliberately selected in such a way that there is a predetermined distance between the location beyond which, in the rated operating state of the catalyst, the diffusion-controlled surface reaction is present and/or beyond which, in the rated operating state of the catalyst, a developed hydrodynamic boundary layer is present and a transition from the inlet sector to the succeeding sector, which predetermined distance is selected in such a way that the heterogeneous combustion reaction is not extinguished in the catalytically active succeeding channels in the rated operating state of the catalyst. Since a very much larger surface area and—depending on the particular embodiment—considerably improved cooling are present at the transition to the succeeding channels, a transition which lies too close to the development length of the boundary layer or too close to the ignition point of the heterogeneous catalyst reaction could lead to the heterogeneous reaction being extinguished.

A particularly inexpensive structure can be achieved for the catalyst according to the invention in particular if the channels are formed by corrugated and/or folded channel plates which are layered on top of one another transversely with respect to the main throughflow direction and the corrugations and/or folds of which extend in the main throughflow direction. The separation walls are in this case formed by separation plates which are arranged transversely with respect to the main throughflow direction between two adjacent channel plates in the succeeding sector. The plates are designed to be catalytically active on at least one side, such that when the catalyst is assembled both catalytically active inlet channels and catalytically active succeeding channels are present. With this design, the separation walls in the form of the separation plates can be integrated in the catalyst even as early as while the catalyst is being built. This considerably simplifies production of the sectors with channels of different internal cross-sectional areas.

In this context, a refinement in which the separation plates are likewise corrugated and/or folded is of particular interest, with the corrugations and/or folds of the separation plates extending parallel to the corrugations and/or folds of the channel plates, and with the corrugations and/or folds of the separation plates having smaller amplitudes than the corrugations and/or folds of the channel plates. This construction ensures that the separation plates form separate succeeding channels with smaller internal cross-sectional areas when the plates are stacked or layered on top of one another in the succeeding sector within the corrugations or folds of the channel plates.

To allow better cooling of the catalyst in order to achieve an increased conversion rate, it is possible for catalytically active channels and catalytically inactive channels to be arranged alternately with one another both in the region of the inlet channels and in the region of the succeeding channels. The flow which is passed through the catalytically inactive channels is then used for cooling, i.e. to dissipate the heat which is formed during the reaction in the catalytically active channels. To achieve a high conversion rate, it is expedient for the catalytically active succeeding channels each to be formed by succeeding channels which are provided with the smaller internal cross-sectional area. For cooling, it is not imperative that the catalytically inactive succeeding channels be equipped with the reduced internal cross-sectional areas, i.e. with the separation walls.

In an advantageous refinement, however, the catalyst has catalytically inactive succeeding channels with a smaller internal cross-sectional area. Installing the separation walls in the catalytically inactive succeeding channels as well allows the flow resistance of the catalytically inactive succeeding channels to be influenced, so that it is possible to influence the distribution of the flow fed to the catalyst between the catalytically active channels and the catalytically inactive channels. By way of example, a distance from the catalyst inlet to the beginning of the catalytically inactive succeeding channels with a smaller internal cross-sectional area may be greater than a distance from the catalyst inlet to the beginning of the catalytically active succeeding channels with a smaller internal cross-sectional area. In this embodiment, the pressure drop in the catalytically active succeeding channels is lower than in the corresponding catalytically inactive succeeding channels. The mass flow of combustible fuel-oxidant mixture through the catalytically active channels is correspondingly greater, with the result that a greater conversion rate of the fuel can be achieved. If, by contrast, the distance from the catalyst inlet to the beginning of the catalytically inactive succeeding channels with a smaller internal cross-sectional area is less than the distance from the catalyst inlet to the beginning of the catalytically active succeeding channels, the pressure drop is lower in the catalytically inactive succeeding channels. This leads to reduced flow velocities in the catalytically active succeeding channels, which allows the heterogeneous reaction to be ignited at relatively low temperatures. Irrespective of their length, the separation walls used to form the catalytically inactive succeeding channels with smaller internal cross-sectional areas can improve the dissipation of the heat which is formed in the catalytically active succeeding channels, since the intermediate walls are heated by the heat radiated from the walls of the adjacent catalytically active channels and at the same time have the cooling mixture flowing around them.

Moreover, narrower succeeding channels, i.e. those succeeding channels which have a smaller internal cross-sectional area, impede spontaneous ignition of a homogeneous combustion reaction in the fuel-oxidant mixture within the succeeding channels, since with smaller internal cross-sectional areas radicals which are formed during the heterogeneous combustion reaction can be bonded more successfully, an action which is also described as an improvement to the “radical quenching” (elimination of radicals).

Further important features and advantages of the invention will emerge from the subclaims, from the drawings and from the associated description of figures with reference to the drawings.

### BRIEF DESCRIPTION OF THE DRAWINGS

Preferred exemplary embodiments of the invention are illustrated in the drawings and explained in more detail in the description which follows, in which identical designations refer to identical or functionally equivalent or similar components. In the drawings, in each case schematically:

FIG. 1 shows a front view of an excerpt of a catalyst according to the invention,

FIG. 2 shows a longitudinal section through a catalyst according to the invention corresponding to section lines II in FIG. 1, but in the form of a different embodiment,

FIG. 3 shows a longitudinal section similar to that shown in FIG. 2, but for a detail in the region of a transition between an inlet channel and two succeeding channels,

FIG. 4 shows a view similar to that shown in FIG. 2, but for a different embodiment.

### WAYS OF CARRYING OUT THE INVENTION

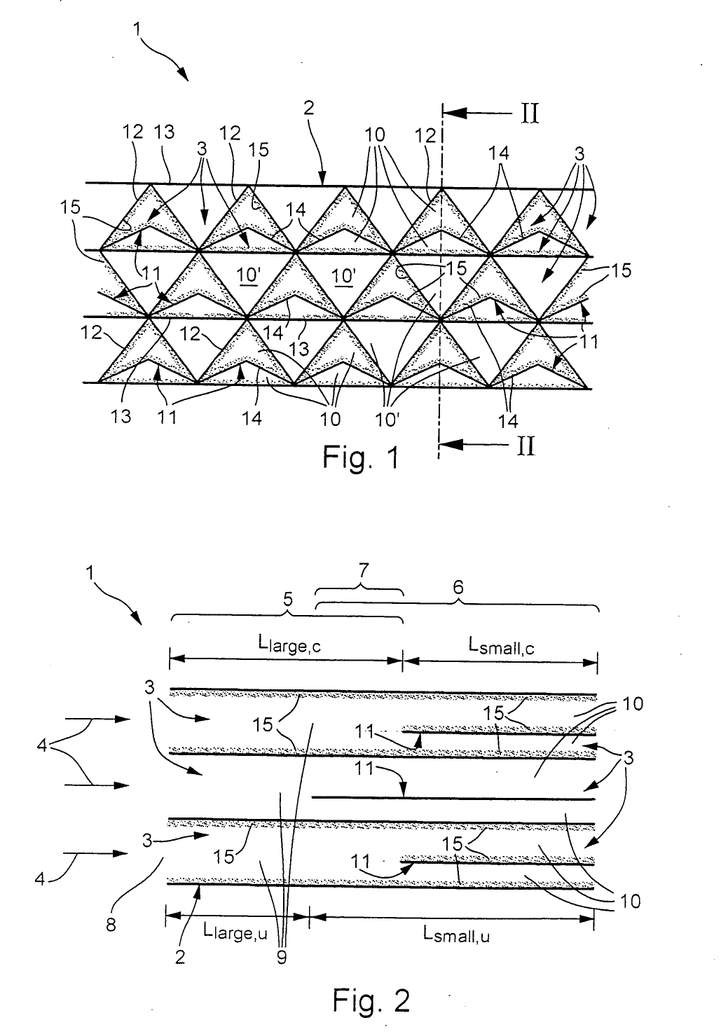

In accordance with FIGS. 1 and 2, a catalyst 1 according to the invention has a structure 2 which has or forms a plurality of channels 3 which run parallel to one another and parallel to a main throughflow direction 4, indicated by arrows in FIG. 2, of the catalyst 1. In the specific embodiment shown here, moreover, the channels 3 run in a straight line.

As can be seen from FIG. 2, the catalyst 1 or its structure 2 is divided into at least two sectors, namely an upstream first sector 5 and a downstream second sector 6, as seen in the main throughflow direction 4. The sectors 5, 6 are marked by curly brackets in FIG. 2, making it clear that the two sectors 5, 6 overlap in a transition region 7 which is likewise marked by a curly bracket. The upstream first sector 5 includes an inlet 8 of the catalyst 1 and is therefore also referred to below as inlet sector 5, whereas the downstream second sector 6 is also referred to below as succeeding sector 6. Accordingly, the inlet sector 5 includes inlet channels 9, while the succeeding sector 6 includes succeeding channels 10.

Inlet sector 5 and succeeding sector 6 differ from one another by virtue of the fact that some of the succeeding channels 10 each have a smaller internal cross-sectional area than the inlet channels 9. In the embodiment shown in FIG. 2, all the succeeding channels 10 have a smaller internal cross-sectional area than the inlet channels 9. By contrast, in the embodiment shown in FIG. 1, there are also succeeding channels, denoted by 10′, which have the same internal cross-sectional area as the inlet channels 9. The succeeding channels 10 which are equipped with a smaller internal cross-sectional area are also referred to below as small or narrow succeeding channels 10, while the others are referred to as large or wide inlet channels 9 or succeeding channels 10′ (FIG. 1).

According to the invention, the small succeeding channels 10 are produced by separation walls 11 being introduced into the channels 3, which pass through the entire structure 2 of the catalyst 1, in the succeeding sector 6. These separation walls 11 divide the respective channel 3 within the succeeding sector 6 into a plurality of, i.e. at least two, parallel, separate partial channels which form the narrow succeeding channels 10. Since the separation walls 11 extend only within the succeeding sector 6, the continuous channels 3 in the inlet sector 5 form the large inlet channels 9. Accordingly, the inlet channels 9 have the same large internal cross-sectional area as the continuous channels 3.

In accordance with FIG. 1, the catalyst 1 can preferably be produced by corrugated and/or folded channel plates 12 being stacked or layered on top of one another in such a way that their corrugations or folds form the channels 3. In the specific embodiment shown here, an intermediate plate 13 is additionally in each case placed between two adjacent channel plates 12, the intermediate plate 13 being unfolded or uncorrugated. As a result, in particular with the corrugation or fold pattern shown by way of example in FIG. 1, the formation of separate channels 3 is considerably simplified, since the intermediate plates 13 separate the adjacent channel plates 12 from one another transversely with respect to the main throughflow direction 4 and thereby prevent peaks and valleys of the corrugations or folds which adjoin one another from sliding into one another. To take account of the separation walls 11 for forming the narrow succeeding channels 10 as early as during this layer structure, separation plates 14 are placed into the structure 2, specifically in each case between two adjacent channel plates 12. In the embodiment shown here, which is equipped with the intermediate plates 13, the separation plates 14 are in each case arranged between a channel plate 12 and one of the adjacent intermediate plates 13.

In this design, therefore, portions of the channels 3 which lie in the inlet sector 5 form the inlet channels 9, while portions of the channels 3 which lie in the succeeding sector 6 include the separation walls 11 and therefore form the succeeding channels 10 (cf. FIG. 2).

It is expedient for the separation plates 14 also to be corrugated and/or folded, with the corrugations or folds of the separation plates 14 running within the corrugations or folds of the adjacent channel plate 12. As a result, the corrugations or folds of the separation plates 14 also extend parallel to the corrugations or folds of the channel plates 12. To allow the narrow succeeding channels 10 to be formed in accordance with the invention within the channels 3 formed by the corrugations or folds of the channel plates 12, the amplitudes of the corrugations or folds of the separation plates 14 are dimensioned to be smaller than the amplitudes of the corrugations or folds of the channel plates 12.

The layer formation of the structure 2 may be effected, for example, by stacking a suitable number of channel plates 12, intermediate plates 13 and separation plates 14 on top of one another. The plates 12, 13, 14 can also be layered on top of one another by being folded to and fro or by being wound up helically. Therefore, after it has been assembled, the catalyst 1 has a common structure 2 or supporting structure 2, which forms an integral unit for the inlet sector 5 and the succeeding sector 6, for all of its channels 3, 9, 10.

The catalyst 1 is used to burn a portion of a gaseous fuel-oxidant mixture which flows through the catalyst 1. A catalyst 1 of this type is preferably used in a burner of a power plant. To enable it to provide its catalytic action, in the embodiment shown here the channel, intermediate and separation plates 12, 13, 14 are each designed to be catalytically active on one side, in particular by coating with a catalytically active layer or catalyst layer 15. When the structure 2 is being assembled, the orientation of the plates 12, 13, 14 is expediently such that catalytically active channels and catalytically inactive channels alternate both in the inlet sector 5 and in the succeeding sector 6. The catalytically inactive channels differ from the catalytically inactive channels in that at least one boundary wall of the catalytically active channels is provided with the catalyst layer 15, whereas none of the boundary walls of the catalytically inactive channels is provided with the catalyst layer 15. By way of example, in FIG. 1 all the narrow succeeding channels 10 are catalytically active, whereas the wide succeeding channels 10′ are catalytically inactive. By contrast, in FIG. 2 the inlet channels 9 and the succeeding channels 10 in the upper and lower channels are catalytically active, whereas the inlet channel 9 and the succeeding channels 10 are catalytically inactive in the middle channel 3. However, it is important that catalytically active succeeding channels are expediently in each case not formed by wide succeeding channels, but rather by narrow succeeding channels 10.

Accordingly, in the embodiment shown in FIG. 2, there are also catalytically inactive narrow succeeding channels 10 which are formed in the middle channel 3. In this context, it is worth noting that the separation walls 11 of the catalytically inactive succeeding channels 10 may have a different length in the main throughflow direction 4 than the separation walls 11 of the catalytically active succeeding channels 10. The different lengths of the separation walls 11 determine the overlap of the segments 5, 6 in the transition region 7. It will be clear that the separation walls 11 of the catalytically active and the catalytically inactive succeeding channels 10 may fundamentally also be of the same size.

In the embodiment shown in FIG. 2, however, the length of the separation walls 11 in the catalytically inactive succeeding channels 10, which is denoted by L_{small,u}, is greater than the length of the separation walls 11 in the catalytically active succeeding channels 10, which is denoted by L_{small,c}. In other words, a distance, denoted by L_{large,u}, between the beginning of the catalytically inactive small succeeding channels 10 and the inlet 8 of the catalyst 1 is in this case less than a distance, denoted by L_{large,c}, between the inlet 8 and the beginning of the catalytically active small succeeding channels 10. This embodiment causes the back-pressure to rise in the catalytically inactive succeeding channels 10, with the result that a greater proportion of the incoming flow of mixture is distributed to the catalytically active succeeding channels 10.

In another embodiment, it is also possible for the length L_{small,u} of the separation walls 11 of the catalytically inactive succeeding channels 10 to be less than the length L_{small,c} of the separation walls 11 in the catalytically active succeeding channels 10. This variant results in reduced flow velocities in the catalytically active channels 3, allowing reliable ignition of the heterogeneous combustion reaction with a shortened path length in particular in the catalytically active inlet channels 9.

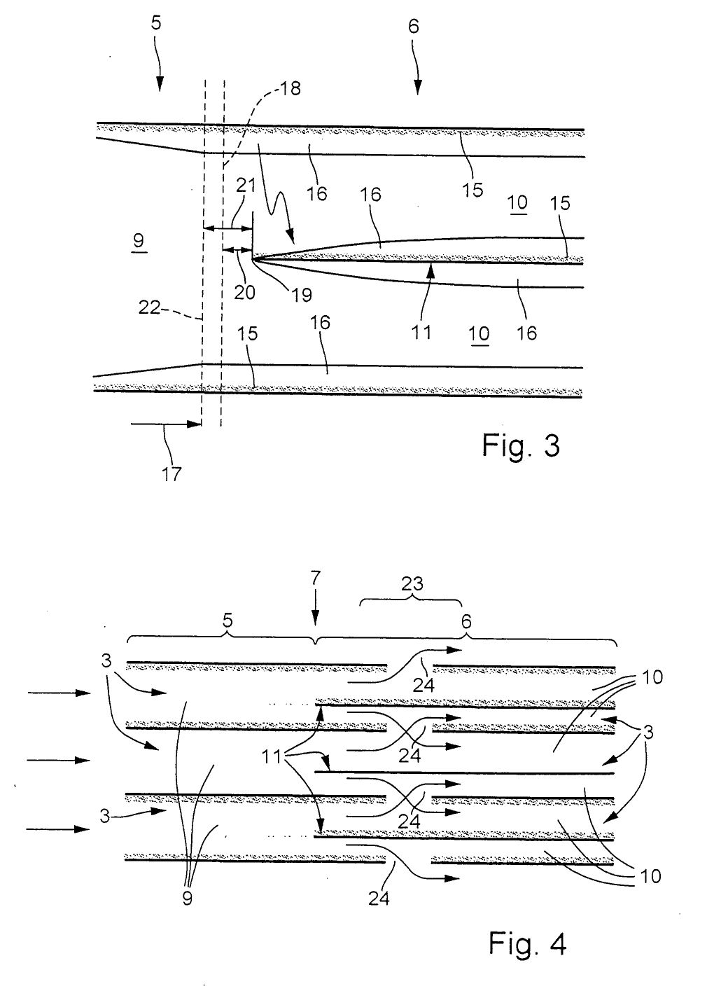

In accordance with FIG. 3, hydrodynamic boundary layers 16 are developed at the walls of the inlet channels 9 and of the succeeding channels 10. A boundary layer 16 of this type begins to develop at a leading edge 19, which is indicated in FIG. 3 at the separation wall 11. After a certain path length, which depends on the particular channel cross section, it is possible for a fully developed boundary layer 16 to build up. The length required to build up the developed boundary layer 16 is also referred to as the development length, which is designated by 17 in FIG. 3. A dashed line symbolizes the end of the development length 17 or the start of the developed boundary layer 16.

In accordance with FIG. 3, the dimensions of the catalyst 1 are expediently such that the separation walls 11 only begin downstream of the development length 17. This takes account of the fact that a developed boundary layer 16 promotes the formation of a diffusion-controlled reaction at the catalytically active surfaces. When the diffusion-controlled reaction is present, the fuel-oxidant mixture has ignited, so that a heterogeneous combustion is present. One possible position beyond which a diffusion-controlled reaction is present is characterized by a further dashed line and denoted by 18 in FIG. 3. It is expedient for the catalyst 1 to be dimensioned such that the separation walls 11 only begin downstream of this location 18, i.e. in a region in which a diffusion-controlled reaction is already present.

The transition between inlet channel 9 and succeeding channels 10 or between inlet sector 5 and succeeding sector 6 within the catalytically active channels 9, 10 is located at the leading edge 19 of the separation wall 11 shown. To ensure that the reaction which has been ignited in the inlet channel 9 is not extinguished during the transition to the succeeding channels 10, the catalyst 1 is dimensioned in such a way that a first distance 20 is maintained between the leading edge 19 or the transition 19 and the beginning 18 of the diffusion-controlled reaction, and a second distance 21 is maintained between the leading edge 19 or the transition 19 and the beginning of the developed boundary layer 16. The boundary line between developing boundary layer and developed boundary layer 16 is denoted by 22 in FIG. 3.

The dimension conditions referred to above in each case relate to a rated operating state of the catalyst 1, i.e. in particular to a rated operating state of the burner equipped with the catalyst 1.

Further dimension criteria may be as follows:

In accordance with FIGS. 2 and 3, the length of the inlet sector 5 in the catalytically active channels 3, i.e. the distance from the inlet 8 to the leading edge 19 of the separation walls 11, is approximately 30 times greater than a mean channel cross section in the inlet sector 5. As an alternative or in addition, the distance between the separation walls 11 and the inlet 8 may also amount to approximately 10-60% of the total length of the catalyst 1. As an alternative or in addition, this distance may be selected to be 10-60 mm.

A further particular feature which results from the construction of the present catalyst 1 according to the invention is that the inlet channels 9, at least in the vicinity of the transition to the succeeding channels 10, can transfer heat to the separation wall 11 through radiation, thereby improving the cooling of the catalyst 1 at least at the end of the inlet sector 5. Calculations have shown that up to 30% of the heat generated by the hot walls can be radiated onto the cooler surfaces. Furthermore, this can boost the catalytic activity at the start of the separation wall 11.

In accordance with FIG. 4, a mixing zone 23, in which flows can flow over from one channel to the adjacent channel, may be formed at the transition between inlet sector 5 and succeeding sector 6 or, as here, directly in the succeeding sector 6. This is achieved by passage openings 24 which are formed in the channel walls. By way of example, these passage openings 24 may be cut out of the channel plates 12 and the intermediate plates 13. The adjacent channels, i.e. in this case the succeeding channels 10, can be placed in communication with one another via these passage openings 24. Since this design causes the fuel-oxidant mixture of the catalytically inactive channels 3, which is used for cooling, to pass into the catalytically active channels 3, it is possible to increase the overall fuel conversion rate.

To increase the residence time of the fuel-oxidant mixture in the catalytically active channels 3 and/or to improve the heat transfer, it is possible for at least some of the small catalytically active succeeding channels 10 to be equipped with turbulence stimulators (not shown here).

To allow better neutralization of the radicals which are formed at high temperatures in the gas phase of the catalytically inactive channels, it is moreover possible to provide for at least some of the narrow catalytically inactive succeeding channels 10 to be provided with a material, for example aluminum or aluminum alloy, which has an absorbing action for these radicals. This neutralization or deactivation of the radicals impedes the ignition of a homogeneous combustion in the gas mixture.

In the embodiment shown in FIG. 4, the separation walls 11 are of equal length for the catalytically active succeeding channels and the catalytically inactive succeeding channels 10, with the result that the transition portion 7 drops toward zero and the successive sectors 5, 6 accordingly do not overlap one another.

The catalytically active coating or catalyst layer 15 can be configured in various ways. By way of example, the catalyst material can be applied in a punctiform manner, in order to produce the maximum possible catalytically active surface areas. It is also possible for the catalyst material to be applied in strips which extend transversely with respect to the direction of flow and are spaced apart from one another in the direction of flow. Furthermore, it is possible for zones with different activities to be distributed appropriately.

### LIST OF DESIGNATIONS

1 Catalyst
2 Structure
3 Channel
4 Main throughflow direction
5 Inlet sector
6 Succeeding sector
7 Transition portion
8 Inlet
9 Inlet channel
10, 10′ Succeeding channel
11 Separation wall
12 Channel plate
13 Intermediate plate
14 Separation plate
15 Catalytic coating
16 Boundary layer
17 Development length
18 Beginning of diffusion-controlled reaction
19 Leading edge
20 Distance
21 Distance
22 Beginning of developed boundary layer
23 Mixing zone
24 Passage opening

1. A catalyst for combustion of at least a portion of a gaseous fuel-oxidant mixture flowing through the catalyst, in particular for a burner of a power plant,
having an inlet sector, which includes an inlet of the catalyst and has inlet channels through which medium can flow in parallel,
having a succeeding sector, which is downstream of the inlet sector, as seen in the main throughflow direction of the catalyst, and has succeeding channels through which medium can flow in parallel,
at least some of the succeeding channels having a smaller internal cross-sectional area than the inlet channels, wherein the inlet channels and the succeeding channels are formed from channels which extend through the inlet sector and through the succeeding sector and have the internal cross-sectional area of the inlet channels,
in that the inlet channels are formed by portions of the channels lying in the inlet sector,
in that the succeeding channels are designed with a smaller internal cross-sectional area by virtue of separation walls being arranged in portions of the channels which lie in the succeeding sector for a plurality or all of the, which separation walls, in the succeeding sector, in each case divide the respective channel portions into at least two succeeding channels.

2. The catalyst as claimed in claim 1, wherein in the case of catalytically active channels the length of the inlet sector in the main throughflow direction is selected in such a way that, in a rated operating state of the catalyst, in particular of the burner equipped with the catalyst, there is a diffusion-controlled reaction within the inlet sector at the catalytic surfaces of catalytically active inlet channels.

3. The catalyst as claimed in claim 1 wherein in the case of catalytically active channels the length of the inlet sector in the main throughflow direction is greater than a development length of a hydrodynamic boundary layer which forms in the inlet channels in a rated operating state of the catalyst, in particular of the burner equipped with the catalyst.

4. The catalyst as claimed in claim 2, wherein there is a predetermined distance between the location beyond which, in the rated operating state of the catalyst, the diffusion-controlled surface reaction is present and/or beyond which, in the rated operating state of the catalyst, a developed hydrodynamic boundary layer is present and a transition from the inlet sector to the succeeding sector, which predetermined distance is selected to be such that the heterogeneous combustion reaction in the catalytically active succeeding channels is not extinguished in the rated operating state of the catalyst.

5. The catalyst as claimed in claim 1, wherein in the catalytically active channels the length of the inlet sector in the main throughflow direction
corresponds to approximately 30 times a mean channel cross section in the inlet sector, and/or
corresponds to approximately 10-60% of the total length of the catalyst, and/or
corresponds to approximately 10-60 mm.

6. The catalyst as claimed in claim 1, wherein
the channels are formed by corrugated and/or folded channel plates which are layered on top of one another transversely with respect to the main throughflow direction and the corrugations and/or folds of which extend in the main throughflow direction,
in that the separation walls are formed by separation plates which are arranged transversely with respect to the main throughflow direction, between two adjacent channel plates in the succeeding sector,
in that the plates are designed to be catalytically active on at least one side, in such a manner that when the catalyst is assembled, catalytically active inlet channels and catalytically active succeeding channels are present.

7. The catalyst as claimed in claim 6,
in that wherein the separation plates are likewise corrugated and/or folded,
in that corrugations and/or folds of the separation plates extend parallel to the corrugations and/or folds of the channel plates, and
in that the corrugations and/or folds of the separation plates have smaller amplitudes than the corrugations and/or folds of the channel plates.

8. The catalyst as claimed in claim 6,
in that wherein an uncorrugated and/or unfolded intermediate plate is arranged between each pair of adjacent channel plates,
in that the separation plates are then in each case arranged between a channel plate and an adjacent intermediate plate.

9. The catalyst as claimed in claim 1, wherein
the catalyst has catalytically active inlet channels and catalytically active succeeding channels, as well as catalytically inactive inlet channels and catalytically inactive succeeding channels, which are arranged alternately,
in that the catalytically active succeeding channels are in each case formed by succeeding channels having a smaller internal cross-sectional area.

10. The catalyst as claimed in claim 9, wherein the catalyst has catalytically inactive succeeding channels with a smaller internal cross-sectional area.

11. The catalyst as claimed in claim 10, wherein a distance (L_{large, U}) from the inlet of the catalyst to the start of the catalytically inactive succeeding channels with a smaller internal cross-sectional area is greater than or less than a distance (L_{large,c}) from the inlet of the catalyst to the start of the catalytically active succeeding channels with a smaller internal cross-sectional area.

12. The catalyst as claimed in claim 1, wherein a mixing zone, in which adjacent channels are connected so as to be in communication with one another, is formed in the succeeding sector or at the transition from the inlet sector to the succeeding sector.

13. The catalyst as claimed in claim 1, wherein at least some of the succeeding channels with a smaller internal cross-sectional area are equipped with turbulence stimulators.

14. The catalyst as claimed in claim 1, wherein at least some of the catalytically inactive succeeding channels are configured with a material which has an absorbing action for radicals which are formed in the gas phase in the rated operating state of the catalyst.

15. The catalyst as claimed in claim 1, wherein the inlet channels and the succeeding channels are formed in a common supporting structure, so that inlet sector and succeeding sector form an integral unit.

16. The catalyst as claimed in claim 1, wherein the catalytically active channels are equipped with a catalytically active coating which is applied continuously, areally, in punctiform fashion and/or in a plurality of strips that are spaced apart from one another in the direction of flow.
